(19) United States
(12) Patent Application Publication
(10) Pub. No.: US 2023/0280214 A1
(43) Pub. Date: Sep. 7, 2023

(54) Temperature Measurement Device

(71) Applicant: Nippon Telegraph and Telephone Corporation, Tokyo (JP)

(72) Inventors: Yurina Tanaka, Tokyo (JP); Yuichi Akage, Tokyo (JP); Takashi Sakamoto, Tokyo (JP); Masahiro Ueno, Tokyo (JP); Sohan Kawamura, Tokyo (JP); Soichi Oka, Tokyo (JP)

(21) Appl. No.: 18/006,823

(22) PCT Filed: Aug. 20, 2020
(86) PCT No.: PCT/JP2020/031389

§ 371 Date: Jan. 25, 2023

(51) Int. Cl. G01K 1/24; G01J 3/26; G01J 3/02

(52) U.S. Cl. CPC G01K 1/24; G01J 3/0286; G01J 3/26

(57) ABSTRACT

A temperature measuring device includes a Fabry-Perot interferometer, a power supply, and a light source. The temperature measuring device observes the light emitted from the light source and transmitted through the Fabry-Perot interferometer and obtains the temperature of a measurement environment in which the Fabry-Perot interferometer is placed. The light source emits a plurality of lights to the Fabry-Perot interferometer.

### CROSS-REFERENCE TO RELATED APPLICATIONS

This application is a national phase entry of PCT Application No. PCT/JP2020/031389, filed on Aug. 20, 2020, which application is hereby incorporated herein by reference.

### TECHNICAL FIELD

The present invention relates to a temperature measuring device.

### BACKGROUND

It is known that dioxins are generated by incomplete combustion of a material containing chlorine such as vinyl chloride pipes. In the 1990s, there were serious social problems such as detection of high-concentration dioxins from the site of a refuse incineration facility. Since then, it has been clarified that the amount of dioxin generated can be suppressed according to the temperature at the time of incineration, and temperature control techniques and temperature measuring techniques of incineration facilities have been developed.

For temperature measurement inside an incineration facility, it is required first for the incineration facility to be able to be used stably even in a high temperature environment. Further, in this type of temperature measurement, it is also required for the temperature measurement to not be easily affected by combustion products such as soot. In addition, in this type of temperature measurement, it is also required for the temperature to be able to follow the temperature change in the furnace which changes from moment to moment. In this type of temperature measurement, it is also required for the temperature distribution in the furnace to be able to be measured. There are technical problems for satisfying these requirements, and improvement in performance of this type of temperature measuring device is currently being studied.

For example, a thermocouple thermometer or a radiation thermometer is used as a temperature measuring device in a conventional incineration facility. The thermocouple thermometer has a probe portion for generating thermoelectromotive force by joining different kinds of metals, and a measurement unit for converting the thermoelectromotive force generated in the probe portion into temperature and displaying the temperature. The radiation thermometer measures the temperature by measuring the Infrared radiation emitted from the object, as shown in PTL 1. Since radiation energy emitted from the object depends on temperature, the amount of energy can be measured and converted into temperature.

### Citation List

### Patent Literature

[PTL 1] Japanese Patent No. 2756648

### Non Patent Literature

[NPL 1] K. Nakamura et al., “Space-charge-controlled electro-optic effect: Optical beam deflection by electro-optic effect and space-charge-controlled electrical conduction”, Journal of Applied Physics,” vol. 104, No.1, 013105, 2008.

### SUMMARY

### Technical Problem

However, there are the following problems described above. First, in the thermocouple thermometer, the probe portion and the measurement unit are generally connected by an electric cable. In the case where a high-temperature portion serving as a measurement region extends over a wide range, an electric cable is installed under a high-temperature environment. In such a case, it is necessary to protect the electric cable from the high temperature environment, and the like, and there is a problem that the facility becomes complicated. On the other hand, in the radiation thermometer, the complication of the facility due to the installation of the cable or the like does not occur, however, in the radiation thermometer, since the emissivity of the radiation energy varies depending on the substance, calibration in accordance with the object of temperature measurement is required, and the temperature of the object is not easily measured accurately.

Embodiments of the present invention have been made to solve the above problems, and an object of embodiments of the present invention is to make a device that can more easily measure an accurate temperature without complicating the facility.

### Solution to Problem

A temperature measuring device according to embodiments of the present invention includes a Fabry-Perot interferometer including a plate-like first component including a first incidence plane and a first emission plane disposed on a side opposite to the first incidence plane, the first component being made of a material having an electrostrictive effect through which light passes, the first incidence plane and the first emission plane being disposed on an optical axis, a plate-like second component including a second incidence plane and a second emission plane disposed on a side opposite to the second incidence plane, the plate-like second component being made of a material through which light passes, the second incidence plane and the second emission plane being disposed on the optical axis, and a distance between the first incidence plane and the second incidence plane being constant on the optical axis, a first reflective film which is formed on the first emission plane and partially reflects light, and a first reflective film which is formed on the first emission plane and partially reflects light, a power supply for applying an electric field to the first component, and a light source for emitting light to the Fabry-Perot interferometer, in which, by observing the light emitted from the light source and transmitted through the Fabry-Perot interferometer, the temperature of a measurement environment in which the Fabry-Perot interferometer is placed is obtained.

### Advantageous Effects of Embodiments of the Invention

As described above, according to Embodiments of the present invention, since, by observing the light emitted from the light source and transmitted through the Fabry-Perot interferometer, the temperature of a measurement environment in which the Fabry-Perot interferometer is placed is obtained; accurate temperature can be measured more easily without complicating the facility.

### BRIEF DESCRIPTION OF THE DRAWINGS

FIG. 1A is a configuration diagram illustrating a configuration of a temperature measuring device according to Embodiment 1 of the present invention.

FIG. 1B is a cross-sectional view illustrating a partial configuration of the temperature measuring device according to Embodiment 1 of the invention.

FIG. 2 is a characteristic diagram illustrating a relationship between temperature and a relative permittivity of a KTN crystal.

FIG. 3 is a configuration diagram illustrating a configuration of the temperature measuring device according to Embodiment 1 of the present invention.

### DETAILED DESCRIPTION OF ILLUSTRATIVE EMBODIMENTS

Hereinafter, a temperature measuring device according to the embodiment of the present invention will be described.

### Embodiment 1

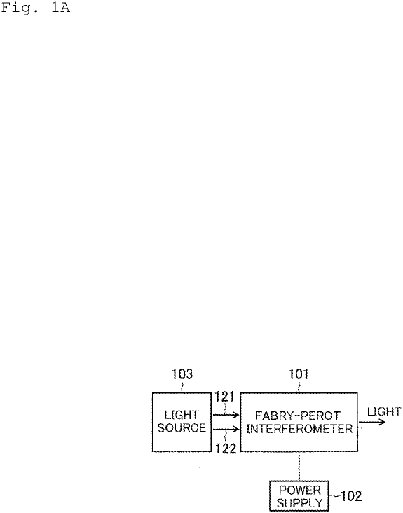

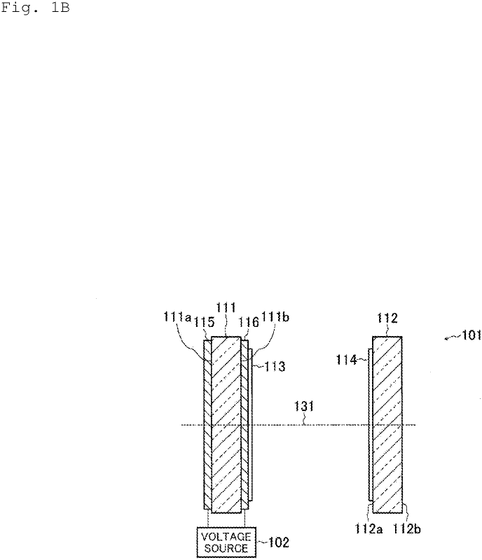

First, a temperature measuring device according to Embodiment 1 of the present invention will be described with reference to FIG. 1A. The temperature measuring device includes a Fabry-Perot interferometer 101, a power supply 102, and a light source 103. The temperature measurement device observes light emitted from the light source 103 and transmitted through the Fabry-Perot interferometer 101, and thus obtains the temperature of a measurement environment in which the Fabry-Perot interferometer 101 is placed.

As illustrated in FIG. 1B, the Fabry-Perot interferometer 101 includes a plate-like first component 111, a plate-like second component 112, a first reflective film 113, a second reflective film 114, a first electrode 115, and a second electrode 116.

The first component 111 is provided with a first incidence plane 111a and a first emission plane 111b disposed on a side opposite to the first incidence plane 111a. In addition, the first component 111 is composed of a material having an electrostrictive effect and transmitting light. The first component 111 can be composed of, for example, a piezoelectric crystal having an electrostrictive effect. The first component 111 is composed of a material having high transparency to light 121 and light 122 in a wavelength band emitted from the light source 103.

A material having an electrostrictive effect and transmitting light consisting the first component 111 is any one of, for example, KTN [KTa₁₋ₐNbₐO₃ (0<α<1)] crystals or lithium-added KLTN [K_{1-β}Li_{β}Ta_{1-α}Nb_{α}O₃ (0<α<1, 0<β<1)] crystals. The KTN crystals and the KLTN crystals are known as crystals having electrostrictive effect. It is known that the electrostrictive effect of these crystals can obtain the amount of distortion proportional to the square of the electric field defined by the distance between the voltage and the electrodes.

In addition, the material having the electrostrictive effect and transmitting light configuring of the first component 111 can be composed of barium titanate (BaTiO₃), lithium niobate (LiNbO₃), calcium fluoride (CaF₂), and the like. In the first component 111, it is important that the surface accuracy (maximum shape error) of the first incidence plane 111a and the first emission plane 111b be about one tenth of the wavelength of target light.

The second component 112 includes a second incidence plane 112a and a second emission plane 112b disposed on the opposite side of the second incidence plane 112a. The second component 112 is composed of a material through which light is transmitted. The second component 112 can be composed of a material having high transparency to light in an object wavelength band. The second component 112 may be made of, for example, BK7 glass or quartz glass.

Here, the first incidence plane 111a and the first emission plane 111b of the first component 111 are disposed on an optical axis (optical path) 131, and the second incidence plane 112a and the second emission plane 112b of the second component 112 are also disposed on the optical axis 131. In addition, the distance between the first incidence plane 111a and the second incidence plane 112a is made constant on the optical axis 131. For example, when the first component 111 and the second component 112 are fixedly disposed on a surface plate (not shown), the distance between the first incidence plane 111a and the second incidence plane 112a can be fixed on the optical axis 131.

In addition, the Fabry-Perot interferometer 101 includes the first reflective film 113 formed on the first emission plane 111b and partially reflecting light, and the second reflective film 114 formed on the second incidence plane 112a and partially reflecting light. The Fabry-Perot interferometer 101 is configured of the first reflective film 113 and the second reflective film 114.

Here, the first emission plane 111b and the second incidence plane 112a are disposed to face each other and can be in a parallel relation to each other. In addition, the first incidence plane 111a and the second emission plane 111b can be in a parallel relation with each other. Similarly, the second incidence plane 112a and the second emission plane 112b can be in a parallel relation with each other.

In a case where a reflection optical system or the like is disposed between the first emission plane 111b and the second incidence plane 112a and the optical axis 131 is bent halfway, the first emission plane 111b and the second incidence plane 112a need not be disposed to face each other. For example, the first emission plane 111b and the second incidence plane 112a can be a surface perpendicular to the optical axis 131. Here, the positional relationship between the first emission plane 111b and the second incidence plane 112a is the same as the relationship between the reflection surface of the first reflective film 113 and the reflection surface of the second reflective film 114.

The power supply 102 supplies a voltage for applying an electric field to the first component 111. For example, the Fabry-Perot interferometer 101 includes the first electrode 115 and the second electrode 116 for applying an electric field to the first component 111, and the power supply 102 is connected to the first electrode 115 and the second electrode 116. In this example, the first electrode 115 is formed on the first incidence plane 111a, and the second electrode 116 is formed between the first emission plane 111b and the first reflective film 113. The first electrode 115 and the second electrode 116 are transparent electrodes. The first electrode 115 and the second electrode 116 can be configured of, for example, indium tin oxide (ITO).

In this example, the distance between the first electrode 115 and the second electrode 116, that is, the plate thickness of the first component 111, is smaller than the beam diameters of the light 121 and the light 122. In the Fabry-Perot interferometer 101, for example, the distance (gap) between the first electrode 115 and the second electrode 116 can be set to 0.1 mm, the distance (distance on the optical axis) between the reflective surface of the first reflective film 113 and the reflective surface of the second reflective film 114 can be set to 10 µm, and the reflectance of the first reflective film 113 and the second reflective film 114 can be set to 99.5%.

The light source 103 emits the light 121 and the light 122 to the Fabry-Perot interferometer 101. In Embodiment 1, the light source 103 emits a plurality of light beams 121 and 122 having different wavelengths from each other, and the temperature of the measurement environment in which the Fabry-Perot interferometer 101 is disposed is obtained from the color of the light transmitted through the Fabry-Perot interferometer 101.

Hereinafter, the KTN crystal will be described. The KTN crystal is known as a crystal having an electrostrictive effect, and a strain proportional to the square of the electric field can be obtained by applying the electric field to the crystal. The relationship between the strain and the electric field is represented by “S to Qε²E² ... (1)”. In Equation (1), S is a strain, Q is an electrostrain coefficient, ε is a dielectric constant, and E is an electric field. From Equation (1), it can be found that the strain of the KTN crystal is proportional to the square of the electric field and proportional to the square of the permittivity. In addition, the permittivity is represented by “ε= εₒεᵣ ... (2)” when the relative permittivity of a substance is taken, and εₒ is the permittivity in vacuum. From Equations (1) and (2), it can be found that the strain of the KTN crystal is proportional to the square of the relative permittivity

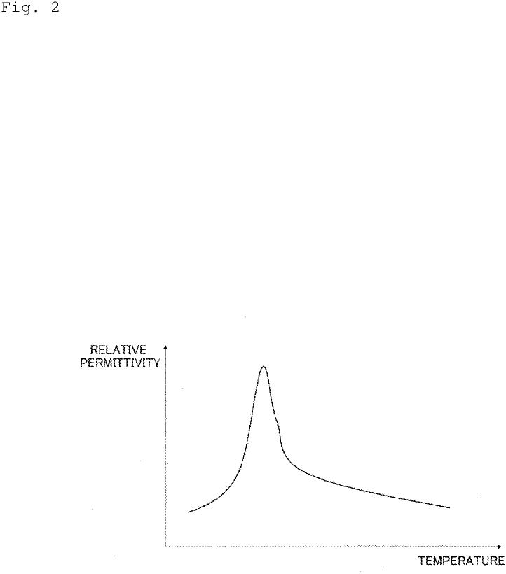

FIG. 2 illustrates the relationship between the temperature and the relative permittivity of the KTN crystal. As illustrated in FIG. 2, it is found that the relative permittivity of the KTN crystal changes with temperature change. The dielectric constant has temperature dependency at the peak of the Curie temperature (Tc). It is known that the Curie temperature can be varied from 100° C. to 400° C. by varying the composition of the crystal. Accordingly, it can be found that the strain of the KTN crystal changes depending on the temperature. In this way, the material having the electrostrictive effect changes its relative permittivity by the temperature change.

On the other hand, in the Fabry-Perot interferometer 101, a resonator structure is formed by the first reflective film 113 and the second reflective film 114, so that only light of a wavelength corresponding to a resonator length which is a distance between them is transmitted. Therefore, the transmission wavelength is changed by changing the resonator length.

Therefore, when the Fabry-Perot interferometer 101 is installed in an environment of a temperature measurement object, the temperature of the first component 111 having an electrostrictive effect reflects a change in the environmental temperature, the relative permittivity changes according to the temperature change, and the distortion changes, thereby changing the transmission wavelength of the Fabry-Perot interferometer 101.

Thus, the environmental temperature can be obtained by, for example, visually observing the light transmitted through the Fabry-Perot interferometer 101 whose transmission wavelength changes in response to a change in the environmental temperature. As described above, according to Embodiment 1, by using visible light as the light source, it is possible to determine the temperature difference without requiring a special light receiver.

In KTN [KTa_{1-α}Nb_{α}O₃ (0 <α <1)], when α is about 0.4, Tc is around 30° C. In addition, the relative permittivity decreases as the temperature increases. According to NPL 1, the KTN crystal has a relative permittivity of 20,000 when the temperature is 40° C. and a relative permittivity of 17,500 when the temperature is 42° C. When the strain amount of the KTN crystal changes from 40° C. to 42° C., the resonator length changes by about 130 nm, where the position at 40° C. is 0.

For example, the Fabry-Perot interferometer 101 configuring the first component 111 from a KTN crystal plate having a driving voltage of 500 V and a thickness of 1 mm by the power supply 102 has a resonator length of 532 nm at 40° C. Further, a case where a red laser (light 121) having a wavelength of 650 nm and a green laser (light 122) having a wavelength of 532 nm are used as the light source 103 is considered. When the temperature of the environment where the Fabry-Perot interferometer 101 is placed changes from 40° C. to 42° C., the wavelength of light transmitted through the Fabry-Perot interferometer 101 changes from red to green. By confirming the color change, it is possible to measure (obtain) the temperature of the environment where the Fabry-Perot interferometer 101 is placed.

By the way, as shown in Equation (1), since the strain (resonator length) is proportional to the square of the electric field, the voltage (driving voltage) supplied from the power supply 102 is increased, it is possible to increase the change in the resonator length of the Fabry-Perot interferometer 101. For example, in the Fabry-Perot interferometer 101 in which the first component 111 is configured of the KTN crystal plate having a plate thickness of 1 mm, the relative permittivity may be changed from 20,000 to 19,500 in order to change the resonator length by about 130 nm when the driving voltage is 1,000 V. In this manner, when the driving voltage is increased, the same change in wavelength as described above can be confirmed with a smaller temperature change. This means that the sensitivity to the temperature change is improved. By changing the driving voltage in this way, the temperature to be measured can be adjusted.

### Embodiment 2

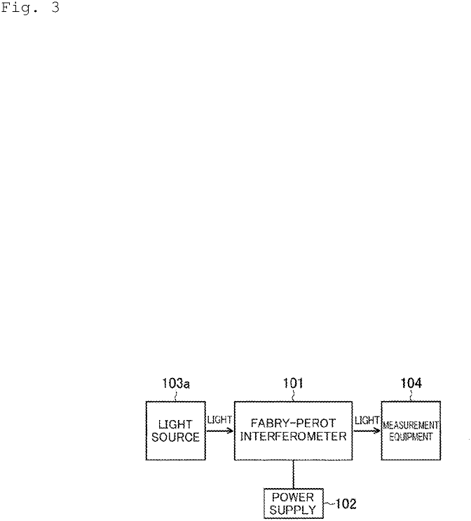

Next, a temperature measuring device to Embodiment 2 of the present invention will be described with reference to FIG. 3. The temperature measuring device is provided with the Fabry-Perot interferometer 101, the power supply 102, a light source 103a, and measurement equipment 104. The temperature measuring device measures (observes) the light emitted from the light source 103 and transmitted through the Fabry-Perot interferometer 101 by the measurement equipment 104, and thereby obtains the temperature of a measuring environment in which the Fabry-Perot interferometer 101 is placed.

The measurement equipment 104 measures the wavelength of the light transmitted through the Fabry-Perot interferometer 101. The measurement equipment 104 can be configured of well-known spectrometers. The wavelength of the measured light is displayed on a display (not shown), for example. By confirming the numerical value of the wavelength displayed on the display, the environmental temperature can be obtained. In Embodiment 2, the light source 103a emits light in an infrared region used for a communication wavelength band. In this case, although the light transmitted through the Fabry-Perot interferometer 101 cannot be visually confirmed, since the light is dispersed by the measurement equipment 104 to measure the wavelength of the light and this value is shown, the difference in wavelength can be confirmed.

By installing the measurement equipment 104 in, for example, a room temperature environment outside the temperature measuring environment, special protection for the measurement equipment 104 and the display is not required. In Embodiment 2, the light source 103a may be configured to emit light including a plurality of wavelengths such as white light. Thus, by using the light source for emitting light having continuous wavelengths, the value of the temperature change can be continuously acquired.

As described above, according to embodiments of the present invention, since the temperature of the measurement environment in which the Fabry-Perot interferometer is placed is determined by observing the light transmitted through the Fabry-Perot interferometer, the accurate temperature can be measured more easily without complicating the facility.

Also, it is apparent that the present invention is not limited to the embodiment described above, and many modifications and combinations can be carried out by those having ordinary knowledge in the art within the technical idea of the present invention.

### REFERENCE SIGNS LIST

101 Fabry-Perot interferometer
102 Power supply
103 Light source
121 Light
122 Light.

1-6. (canceled)

7. A temperature measuring device comprising:
a Fabry-Perot interferometer including:
a plate-like first component including a first incidence plane and a first emission plane disposed on a side opposite to the first incidence plane, the plate-like first component being made of a material having an electrostrictive effect through which light passes, the first incidence plane and the first emission plane being disposed on an optical axis;
a plate-like second component including a second incidence plane and a second emission plane disposed on a side opposite to the second incidence plane, the plate-like second component being made of a material through which light passes, the second incidence plane and the second emission plane being disposed on the optical axis, and a distance between the first incidence plane and the second incidence plane being constant on the optical axis;
a first reflective film on the first emission plane and configured to partially reflect light; and
a second reflective film on the second incidence plane and configured to partially reflect light;
a power supply configured to an electric field to the plate-like first component; and
a light source configured to emit light to the Fabry-Perot interferometer, wherein a temperature of a measurement environment in which the Fabry-Perot interferometer is placed is obtained in accordance with observed light emitted from the light source and transmitted through the Fabry-Perot interferometer.

8. The temperature measuring device according to claim 7, wherein:
the light source is configured to emit a plurality of light beams having different wavelengths from each other, and
the temperature of the measurement environment in which the Fabry-Perot interferometer is placed is obtained from a color of the light transmitted through the Fabry-Perot interferometer.

9. The temperature measuring device according to claim 7, further comprising:
measurement equipment configured to measure a wavelength of light transmitted through the Fabry-Perot interferometer.

10. The temperature measuring device according to claim 7, further comprising:
a first electrode and a second electrode configured to apply the electric field to the plate-like first component, wherein the power supply is connected to the first electrode and the second electrode.

11. The temperature measuring device according to claim 10, wherein:
the first electrode and the second electrode are each formed of a transparent electrode;
the first electrode is disposed on the first incidence plane; and
the second electrode is disposed between the first emission plane and the first reflective film.

12. The temperature measuring device according to claim 10,
wherein the material having an electrostrictive effect and transmitting light is any one of KTN [KTa_{1-α}Nb_{α}O₃ (o<α<1)] crystals or lithium-added KLTN [K_{1-β}Li_{β}Ta_{1-α}Nb_{α}O₃ (o<α<1, o<β<1)] crystals.

13. A method comprising:
providing a Fabry-Perot interferometer including:
a plate-like first component including a first incidence plane and a first emission plane disposed on a side opposite to the first incidence plane, the plate-like first component being made of a material having an electrostrictive effect through which light passes, the first incidence plane and the first emission plane being disposed on an optical axis;
a plate-like second component including a second incidence plane and a second emission plane disposed on a side opposite to the second incidence plane, the plate-like second component being made of a material through which light passes, the second incidence plane and the second emission plane being disposed on the optical axis, and a distance between the first incidence plane and the second incidence plane being constant on the optical axis;
a first reflective film on the first emission plane and configured to partially reflect light; and
a second reflective film on the second incidence plane and configured to partially reflect light;
applying, by a power supply, an electric field to the plate-like first component;
emitting, by a light source, light to the Fabry-Perot interferometer; and
obtaining a temperature of a measurement environment in which the Fabry-Perot interferometer is placed is obtained based on observed light emitted from the light source and transmitted through the Fabry-Perot interferometer.

14. The method according to claim 13, wherein:
the light source is configured to emit a plurality of light beams having different wavelengths from each other, and
the temperature of the measurement environment in which the Fabry-Perot interferometer is placed is obtained from a color of the light transmitted through the Fabry-Perot interferometer.

15. The method according to claim 13, further comprising:
measuring a wavelength of light transmitted through the Fabry-Perot interferometer.

16. The method according to claim 13, wherein applying the electric field to the plate-like first component comprises applying the electric field through a first electrode and a second electrode, wherein the power supply is connected to the first electrode and the second electrode.

17. The method according to claim 16, wherein:
the first electrode and the second electrode are each formed of a transparent electrode;
the first electrode is disposed on the first incidence plane; and
the second electrode is disposed between the first emission plane and the first reflective film.

18. The method according to claim 13,
wherein the material having an electrostrictive effect and transmitting light is any one of KTN [KTa_{1-α}Nb_{α}O₃ (o<α<1)] crystals or lithium-added KLTN [K_{1-β}Li_{β}Ta_{1-α}Nb_{α}O₃ (o<α<1, o<β<1)] crystals.
